(19) United States
(12) Patent Application Publication
(10) Pub. No.: US 2003/0159068 A1
(43) Pub. Date: Aug. 21, 2003

(54) Personal identification system and method for carrying it out

(76) Inventors: Eamus James Halpin, High Wycombe (GB); Simon Charles Papworth, Maidenhead (GB)

Correspondence Address: BEEM PATENT LAW FIRM, 53 W. JACKSON BLVD., SUITE 1352, CHICAGO, IL, 60604-3787, US

(21) Appl. No.: 10/213,851

(22) Filed: Aug. 7, 2002

(30) Foreign Application Priority Data
Feb. 20, 2002 (GB) 0203988.1

(51) Int. Cl. H04L 9/00

(52) U.S. Cl. 713/201

(57) ABSTRACT

A personal identification system for use in providing identification for access to a web site from a user location comprises a web passport certificate; a mobile device associated with said web passport; request means at said web site for requesting further identification; access means at said web site for accessing data from the web passport certificate and identifying said mobile device associated therewith; supply means at said web site for supplying a unique identification code to said mobile device; input means at said location for inputting said unique identification code; comparison means at said web site for comparing said inputted identification code with the identification code sent to said mobile device, and permit means at said web site for permitting access to the web site in dependence on the comparison of said identification codes.

This application claims priority to the United Kingdom Patent Application Serial No. 0203988.1, filed on Feb. 20, 2002 in the British Patent Office.

### BACKGROUND OF THE INVENTION

1. Field of the Invention

This invention relates to an electronic personal identification system and method for carrying it out.

2. Description of the Related Art

In dealings with the internet, it is often desired to access secure sites containing, for example, confidential information which should only be accessible to certain users who have the right to access this information. Currently, this type of confidentiality is often protected by the use of passwords allocated to users and such passwords are usually related directly to the site concerned. Thus a user may have a large number of passwords allocated to him, each of which has to be entered individually to access each site. This can be very time consuming.

To overcome this, there are now systems which allow a single security check to be made on a number of sites who subscribe to the system. One such system is the Microsoft Net Passport (MS Passport). This is a well known system and will not be considered in any detail here.

However, while the MS Passport system provides a considerable amount of security, what it does not do is to take any steps to insure that the person who has gained access to and is using the passport and is thus enabled to access the protected sites is actually the person who is the owner of the passport.

People can gain access to passports belonging to other people generally in one or two ways:

1. They gain access to a computer which is up and running with a MS Passport authentication in place.

2. They gain access to a computer in which details for the authentication are stored for use so that the user is not required to remember the details.

The present invention seeks to provide a personal identification system which will ensure that the person using the passport is the person to whom the passport authentication certificate has been issued.

### BRIEF SUMMARY OF THE INVENTION

According to a first aspect of the invention, there is provided a personal identification system for use in providing identification for access to a web site from a user location. The personal identification system comprises a web passport certificate, request means at said web site for requesting further identification, access means at said web site for accessing data from the web passport certificate and identifying a mobile device associated therewith, supply means at said web site for supplying a unique identification code to said mobile device, receiving means at said web site for receiving an inputted identification code from said user location, comparison means at said web site for comparing said inputted identification code with the identification code sent to said mobile device, and permit means at said web site for permitting access to the web site in dependence on the comparison of said identification codes.

According to a second aspect of the invention, there is provided a personal identification system for use in providing identification for access to a web site from a user location. The personal identification system includes a web passport certificate, a computer at said web site for performing the steps of requesting further identification, accessing data from the web passport certificate and identifying a mobile device associated therewith, and supplying a unique identification code to said mobile device, and an input device at said location for inputting said unique identification code received by said mobile device, wherein said computer can compare the inputted identification code with the identification code sent to the mobile device and permit or deny access to said web site in dependence on said comparison.

According to a third aspect of the invention, there is provided a method of personal identification for use in providing identification for access to a web site from a user location. The personal identification method comprises the steps of obtaining a web passport certificate; generating at the web site a request for further identification; receiving at said location said request for further identification; accessing at said web site data from the web passport certificate and identifying a mobile device associated therewith; supplying from said web site a unique identification code to said mobile device; receiving at said location said unique identification code on said mobile device; inputting at said location said unique identification code; comparing at said web site said inputted identification code with the identification code sent to said mobile device, and permitting at said web site access to the web site in dependence on the comparison of said identification codes.

The invention will now be described in greater detail, by way of example, with reference to the drawings.

### BRIEF DESCRIPTION OF THE SEVERAL VIEWS OF THE DRAWINGS

FIG. 1 is a view of a web screen showing a Microsoft web site.

FIG. 2 is a view of a web screen showing a net passport sign in.

FIG. 3 is a view of a web screen showing a request for further identification.

FIG. 4 is a view of a web screen showing a unique pass code input.

### DETAILED DESCRIPTION OF THE INVENTION

The basic concept of the invention starts from the idea of a web passport. Fundamentally a web passport is an authentication system which allows an authenticated user with a web passport in their browser, to gain access to any web site that requires that level of authentication without having to re-authenticate. The certificate is non-exportable from the browser (it is held in an encrypted RSA downloadable plug-in) and dies when the browser is shut down.

The web passport does not require a two factor strong authentication in order to deliver the digital certificate to the end user.

What the present invention seeks to do is to enable an extra identification factor to be readily introduced into the web passport system to provide extra security.

The further factor involved in this invention, is the provision of a unique identification number representing the actual owner of the web passport. This number would be delivered to the actual owner by means of a mobile device in the actual owner's possession, such as a mobile phone or pager.

RSA have developed a way of delivering “next” SecurID algorithm number without the user having to generate the number themselves via either a hard or a soft token. The unique number can then be delivered via an SMS (Short Message Service) or as a text message to the user's mobile phone.

The present invention resides in the combining of the web passport with the SecurID number in a form which should prove acceptable to both users and web site owners.

Taking the example of MS Web Passport and SecurID number, the combination, for convenience referred to as MIR Services, can work in number of ways

Phase 1:

Mode A: Generic MS Passport sign-in mode (i.e. as it is today)

Mode B: Use MIR Service to access MS Passport

Mode C: Access the MIR Service having already signed-in to MS Passport elsewhere

Phase 2:

Mode D: Use MS Passport and MIR authentication services and Web Passport

Mode A—Generic MS Passport Sign-in (i.e. Same as it is Today)

Within the current implementation of MS Passport the user is required to authenticate themselves by providing a user name and password.

Mode B—Use MIR Service to Access MS Passport

This assumes that the end user hasn't already signed-in to MS Passport and therefore needs to do so when he/she hits the web site of their choice. This mode will be used when users are accessing services through their standard interface device to the web and particularly when they are accessing through their no-standard devices i.e. a Cyber Café or an Airport Lounge.

This is where the MIR service requires the user to strongly authenticate themselves before gaining access to the services available on this site, specific examples being shopping services and on-line banking. The user can browse but, the minute the user wants to complete a transaction, function, or to access specific information where they are required to authenticate themselves then they are automatically asked to strongly authenticate themselves using the MIR service in to MS Passport.

The user will be requested to enter a user name and PIN associated and upon entering this information the MIR service will generate a one-time passcode which will be sent to the user (via an alternative channel—initial channel will be SMS) and upon receipt of this information the user will enter this one-time passcode, which is received by the MIR service. The MIR service validates that the combination of the PIN and the one-time code and authenticate the user. The user will then have access to all of their MS Passport information until they end the session or log-out from Passport.

In the scenario where an organization decides to implement transactional level authentication or the requirement for a user to initially authenticate themselves to MS Passport this will be completed as in Mode C identified below.

Mode C—Access the MIR Service Having Already Signed-in to MS Passport

With the integration of MS Passport into Microsoft's suite of products users could be signing-in to MS Passport at a very early stage in their daily computer usage. Some examples include; users of Instant Messaging (IM) who need a MS Passport to gain access to this service and Microsoft already allows users to automatically sign-in to IM whenever they login to their machines. So in an increasing number of cases users will have already signed-in to MS Passport before they ever go anywhere near the web via a browser.

In this case where the user has initially authenticated themselves to MS Passport (via user name and password) and once they decide to complete a specific transaction, access specific information, or perform a specific function, they will be asked to strongly authenticate themselves. If the web site is a site that authenticates using MS Passport and MIR Services, then by virtue of the fact that the user will have already signed-in to MS Passport it will know who the username of the user is.

In this way MS Passport sign-in can allow a considerable amount of navigation around a site (range of sites) while the MIR Service allows the user access to those parts of the site that are of a data sensitive nature. This implementation of the MIR Service will enable enterprises to implement stronger levels of authentication for the transactions that have a higher risk profile associated with them or specific users who require greater levels of authentication. The authentication process is as identified in Mode B above.

Phase 2: Use MS Passport and MIR Authentication Services and Web Passport

In Phase 2 the customer will authenticate himself or herself to MS Passport (as identified in Mode B and C above) and once they have completed this, the user will be prompted to allow a plug-in to be download so that the Digital Certificate can be streamed. If the device has already used a RSA Web Passport then a plug-in will not be required in order to get their Web Passport. Once their Web Passport has been downloaded in to the Browser, the user is able to digitally sign transactions and use their digital credential for a range of additional on-line services. In this case the user will also be allowed to access sites that only require a strongly authenticated user but do not require the use of digital certificates.

If we analyze Phase 2 even further we will see some of the additional benefits for migrating to this Phase. For a known user coming to a web site that has already signed-in to MS Passport via the MIR service and has downloaded their Web passport, single sign-on now becomes extremely useful. The time taken to sign-in to the Web site is replaced by the web site recognizing and accepting the credentials passed by MS Passport and/or the MIR Service Digital Certificate. The user no longer has to remember a proprietary combination of username/password combinations for every site they visit (even though these may be usefully remembered by their browser, therefore making them even more un-secure), while at the same time the web-site vendor can provide a seamless personalized service to each recognized user at the earliest opportunity.

Within all of the modes identified above the users may be authenticating themselves in different stages within their PC experience. However, the crucial component is that our goal is to provide authenticated users to enterprise in a user-friendly manner.

Let us take the example where the user has signed up for authenticated access from four separate and unrelated web sites. If the user uses IM it would be relatively easy for any or all of the web-sites to use this as a medium to chat, speak or pass information to the user as soon as he/she signs-in to the MS Passport and MIR Services. The user's Internet bank may be configured (by the user) to send the latest bank balance by IM direct to that end user every time he/she signs-in, whether the user plans to go to the web-site or not. As the bank will have all the end users details it would be very straightforward to request to be added to a users “buddy list” (in fact it could be completed as part of the users sign-up process to the web-site) and then use this as a communication medium in order to provide better customer service. Of course, this information could be just as easily provided to the user's mobile phone if required.

The point is that because the user has authenticated to the service, then the web site should be comfortable that they are sending data to the real end user, not an impostor. This is irrespective of the fact that any data transfers will be provided via an SSL encrypted session. A real-time, authenticated personal information service would be a very valuable addition to any web site, let alone one as generic as IM.

Upon verification of the authentication, one of two things will happen. If the user has a browser that has had a MIR Service Digital Certificate in it previously, the new certificate will simply stream to that browser plug-in in background and the process will complete with the end user being re-directed to the web site as an authenticated user. If the user has never authenticated from this browser before, then he/she will be prompted to allow the plug-in to download before the Digital Certificate can then be streamed to it.

As with most “mode” descriptions or diagrams, they tend to look quite complex because of the level of detail that they go down to. Although behind the scenes a lot of work is done here through re-direction, from the user's perspective this will all look quite seamless, while the web-site experience will always be continuous with the style of the web site being visited.

While there are a number of scenarios identified in each of the Modes above there are a number of features that are common across these different implementations. It is assumed that any user that decides to sign-out of MS Passport should be automatically signed-out of the MIR Service simultaneously. There are theoretical reasons why this may not be the case, so the assumption may still be open to debate. If however it is the case, then a programmatic change will have to be considered for the MIR Service, in order to remove the Digital Certificate from the browser before the browser session is over. In all of the cases above the MS Passport information, Web Passport will be erased from the desktop once the user has closed the browser/decided to log-off from MS Passport.

Unlike the normal usage of MS Passport, the MIR Service will need an initial level of profile management for each user. This is primarily around the requirement for the end-user to change the mobile phone number being used by the service to send the next one-time passcode number to. People change phones and numbers on a frequent basis and therefore the user must have the ability to change his/her profile to reflect this at any time. Losing a mobile phone, similar to losing a SecurID token, is not a security risk as the user still has a username, a password and a PIN number in order to keep their information secure.

Profile management in itself though causes a potential security problem. If the profile of a user is allowed to be changed, without authentication being required beforehand then the system can potentially be compromised. However, if the user loses their mobile phone then they won't have the capability to authenticate through the normal route and will therefore be unable to continue using the system. This is obviously not viable.

One possible solution is to make it compulsory for the end user to enter their old phone number as well as having their new phone & number available when any change to the profile is being made. That way when the profile change is complete the MIR Service can request authentication from the new device before the change is accepted. If this mechanism is proven to be successful then web-site vendors could also adopt it in order to control profile changes to the web sites themselves in an authenticated manner. We anticipate that the profile management service to be provided by iRevolution. Please note that perhaps a subtle difference provided by this form of authentication may be that the end user does not have to accept (or wait to download) a Digital Certificate to their browser if they don't want to or don't intend to visit a site at this time. We would expect to be able to give the user this choice upon authentication.

Other possibilities with the invention include the possibility of using a profile mechanism to allow a user to request that access to certain sites require the user in question to be authenticated to in order to gain access to them, even though the web-site itself does not require anything more than MS Passport credentials passed to it. This could be for home users that have multiple family members using the same browser (even though they can have separate login credentials to the PC via Windows XP now), where the browser remembers such aspects as MS Passport credentials for easy sign-in. It might also be useful for users to be sent text messages, as a means of security, when certain functions are performed on certain web sites, thus making them aware of any potential intrusion.

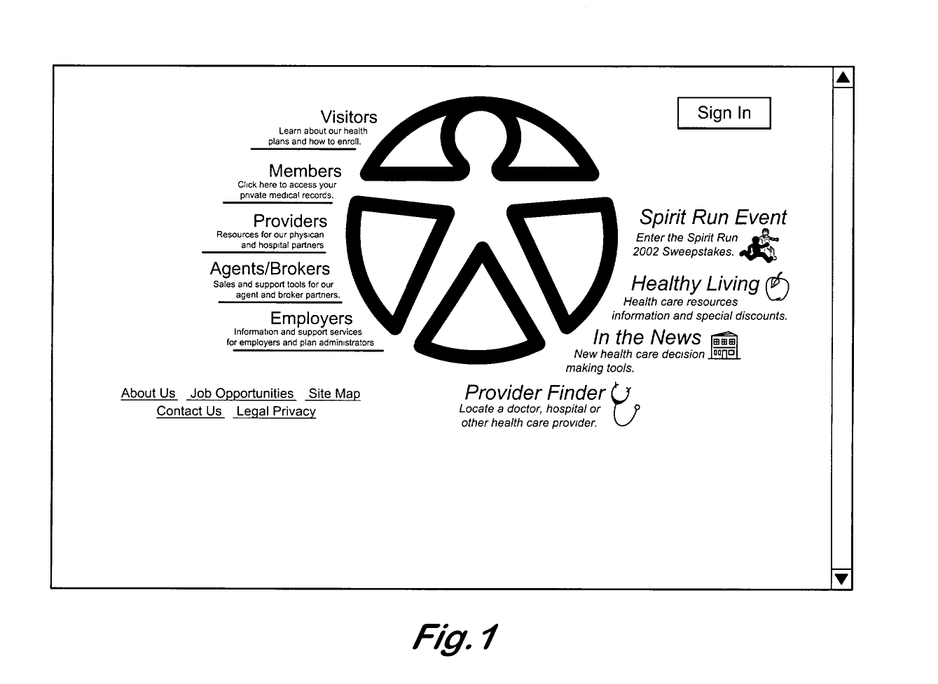

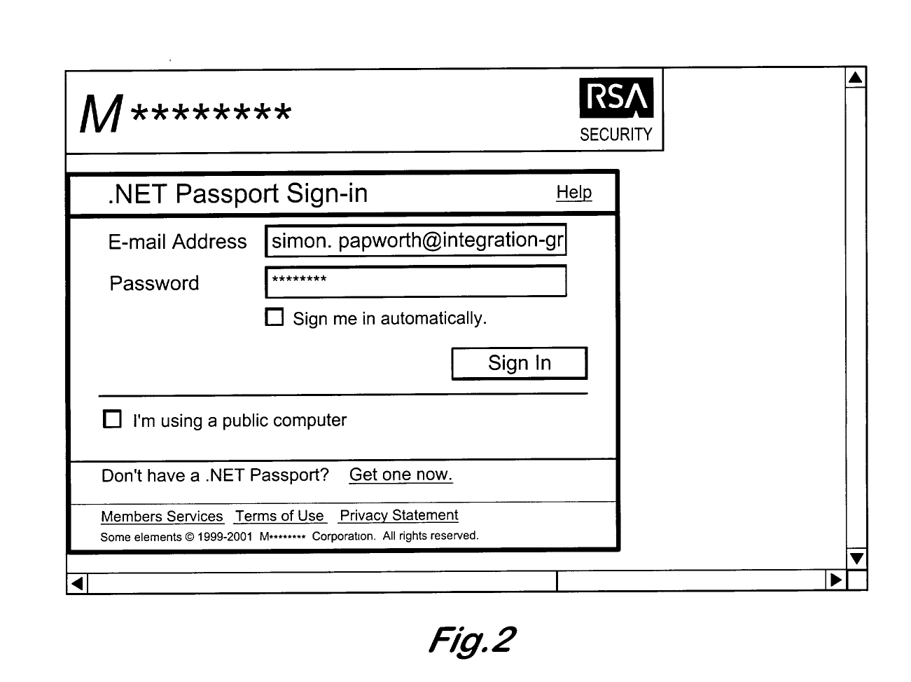

There will now be discussed a detailed example of the operation of the invention. Firstly the user enters any MS Web Passport protected site. A screen, such as that shown in FIG. 1 will appear. Before access is allowed to any personal data or secured data, the user must authenticate their user name and password with the Microsoft.net website using a screen such as shown in FIG. 2.

Once the user has correctly authenticated using Microsoft.Net passport their computer is sent a cookie, and the web site they are accessing displays the Sign Out button. A cookie is a small amount of transient data sent from a web server to the user to keep track of some aspect of the user's use of a web site.

The user has now authenticated with the Microsoft.Net passport protected web site; however there is no physical proof that the user is who they claim to be and not an impostor who has access to the users computer because they have found a computer turned on and logged in.

Authenticating with Microsoft.Net Passport has allowed the web site which wants to make use of Physical Authentication security for secure data or personal information available to use the MIR project by adding an intermediate link <HREF> to the part of their web site that they wish to provide with a higher level of security. In this example it is the Members link.

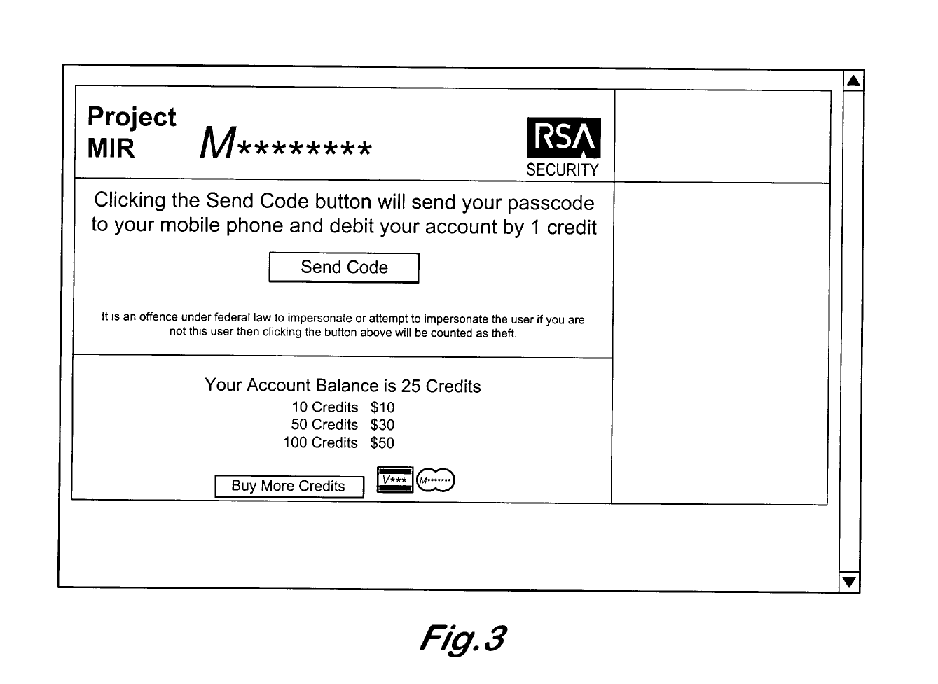

When the user selects the protected link they are redirected to the MIR web site, which uses Microsoft.Net passport to gather their unique user identity and cross reference it to a mobile phone number, once they use the Microsoft.NET sign in button. The user sends instructions to send the code number (FIG. 3)

The user's unique Microsoft passport ID is now cross referenced to find the users Mobile phone number (entered by the user when registering for the service) and a random once off time limited code is sent to the User's mobile phone using text messaging. The text message arrives as quickly as five seconds.

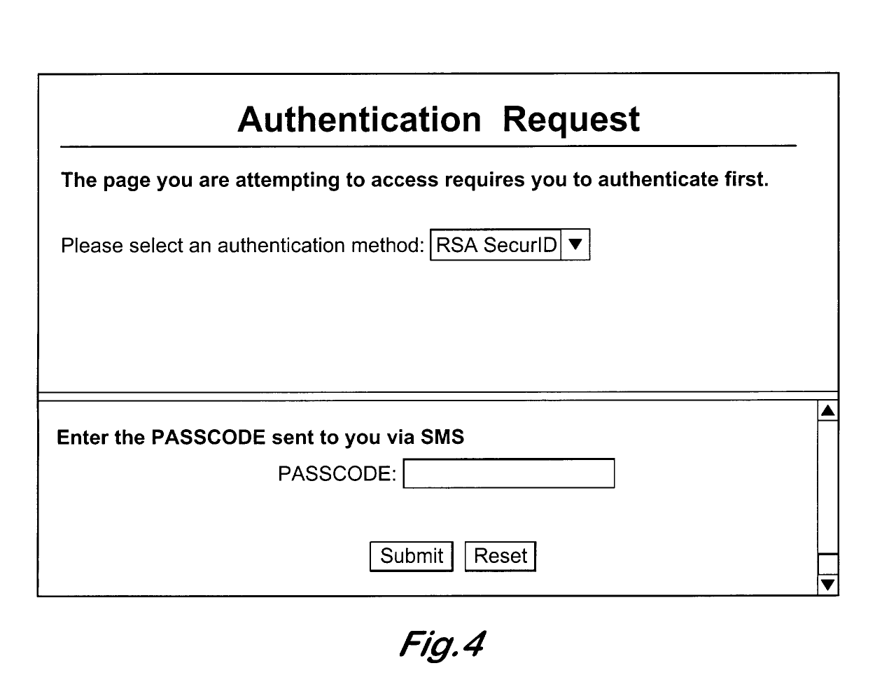

The user is then automatically referred back to the original website link where the user's PIN code and passode are requested and authenticated against the MIR servers using encrypted data transfer (FIG. 4)

The following is an example of one person's use of the MIR system

Sarah is a housewife and regularly goes to hotmail.com in order to access her mail. In order to get to the site she must sign-in to MS Passport, which she does. After reading her mail she decides that she needs to do the weekly shopping so she points her browser at tesco.com. When she gets to the site it welcomes her personally and configures the homepage for her particular shopping style as the site has received her credentials from MS Passport, thus making it a pleasant experience for her already.

When the time comes to pay for her goods, Tesco, for ease and convenience, already has the details of the last credit card used to pay at this site. However, before displaying it on the screen to be checked/used Tesco informs Sarah that they require authentication from her, for her ‘added safety’ and to ‘protect her from on-line credit card fraud’. The browser asks Sarah to turn her mobile phone on and to have it ready.

This is not the first time Sarah has been asked to authenticate her credit card details but it was useful that the homepage reminded her to get her phone as she was signing in, as she had left it downstairs.

The browser asks Sarah to enter her authentication number into the box provided and gives her some on-screen help in how to achieve this, in case she's forgotten. Very shortly afterwards Sarah hears the familiar tones of a text message being delivered to her mobile phone. On opening the message she sees that it contains a six digit number. She takes the number and enters it into the box provided in conjunction with a four digit PIN that she always has in her head (as it's the same as the number she uses for her ATM card). The number is transmitted to the web site, where it is received, and compared with the number that was sent to Sarah's mobile device.

Once the number is received by the web site, Sarah is instantly authenticated to the site and is permitted to continue with her transaction, safe in the knowledge that no one could process transactions on her credit card at this site without the information that she has just typed in. She also realizes that the text message number changes every time. The whole process of authentication has taken less than fifteen seconds to complete from the time she proceeded to the check-out.

She doesn't know how it works, but she feels secure. She also has the comfort of knowing that she can use the same system to access her bank details at egg.com or to book a holiday at expedia.com, from any point of access to the Internet, anywhere in the world.

This is the fundamental way in which we see many users taking the first steps to protecting themselves, and their personal details, while using the world's best known Internet sites. The ease of interaction of MS Passport and MobileID is key here. Only by knowing who the user is through their MS Passport credentials can we deliver the text message to their mobile phone. For Sarah however, this is a seamless experience.

For the vendor in question (tesco.com) it couldn't be easier. Both the sign-in and authentication mechanisms are handled by third parties and therefore significantly reduce the cost of management for the site in total while, at the same time, users are drawn to the site because of the convenience of ease of sign-in through MS Passport and the comfort of added security when required.

It will be appreciated that the above described system and method provide a system and method which provides additional security in the sense of providing greater personal identity security as opposed to mere passport systems using name and password.

The present invention is not limited to the above described embodiments but should be limited only by the following claims.

What is claimed is:

1. A personal identification system for use in providing identification for access to a web site from a user location comprising:
a web passport certificate;
request means at said web site for requesting further identification;
access means at said web site for accessing data from the web passport certificate and identifying a mobile device associated therewith;
supply means at said web site for supplying a unique identification code to said mobile device;
receiving means at said web site for receiving an inputted identification code from said user location;
comparison means at said web site for comparing said inputted identification code with the identification code sent to said mobile device, and
permit means at said web site for permitting access to the web site in dependence on the comparison of said identification codes.

2. A personal identification system as set forth in claim 1, wherein said unique identification code sent by said supply means is time limited.

3. A personal identification system as set forth in claim 2, wherein said mobile device is a mobile phone or pager.

4. A personal identification system as set forth in claim 3, wherein change means are provided for enabling the identity of the mobile device to be varied in relation to the web passport certificate.

5. A personal identification system as set forth in claim 4, wherein said change means includes means for authenticating the change of identity of the mobile device.

6. A personal identification system as set forth in claim 5, wherein said change means includes means for receiving the original identity of the mobile device and means for comparing the original identity of the mobile device with the identity of the mobile device currently associated with said web passport as authentification for the change of identity.

7. A personal identification system for use in providing identification for access to a web site from a user location comprising:
a web passport certificate;
a computer at said web site for performing the steps of requesting further identification, accessing data from the web passport certificate and identifying a mobile device associated therewith, supplying a unique identification code to said mobile device; and
an input device at said location for inputting said unique identification code received by said mobile device;
wherein said computer can compare the inputted identification code with the identification code sent to the mobile device and permit or deny access to said web site independence on said comparison.

8. A personal identification system as set forth in claim 7, wherein said unique identification code sent to said mobile device is time limited.

9. A personal identification system as set forth in claim 8, wherein said mobile device is a mobile phone or pager.

10. A personal identification system as set forth in claim 9, wherein change means are provided for enabling the identity of the mobile device to be varied in relation to the web passport certificate.

11. A personal identification system as set forth in claim 10, wherein said change means includes means for authenticating the change of identity of the mobile device.

12. A personal identification system as set forth in claim 11, wherein said change means includes means for receiving the original identity of the mobile device and means for comparing the original identity of the mobile device with the identity of the mobile device currently associated with said web passport as authentification for the change of identity.

13. A method of personal identification for use in providing identification for access to a web site from a user location comprising:
obtaining a web passport certificate;
generating at the web site a request for further identification;
receiving at said user location said request for further identification;
accessing at said web site data from the web passport certificate and identifying a mobile device associated therewith;
supplying from said web site a unique identification code to said mobile device;
receiving at said user location said unique identification code on said mobile device;
inputting at said user location said unique identification code;
comparing at said web site said inputted identification code with the identification code sent to said mobile device, and
permitting at said web site access to the web site in dependence on the comparison of said identification codes.

14. A method of personal identification as set forth in claim 13, wherein said unique identification code sent by said web site is time limited.

15. A method of personal identification as set forth in claim 14, wherein said mobile device is a mobile phone or pager.

16. A method of personal identification as set forth in claim 15, wherein the method further comprises enabling the identity of the mobile device to be varied in relation to the web passport certificate.

17. A method of personal identification as set forth in claim 16, wherein the method further comprises authenticating the change of identity of the mobile device.

18. A method of personal identification as set forth in claim 17, wherein the authenticating of the change of identity of the mobile device includes inputting the original identity of the mobile device and comparing the original identity of the mobile device with the identity of the mobile device currently associated with said web passport as authentification for the change of identity.
